(19) United States
(12) Patent Application Publication
(10) Pub. No.: US 2024/0369839 A1
(43) Pub. Date: Nov. 7, 2024

(54) THREE-DIMENSIONAL PRINTED OPTICAL LENS ON A SUBSTRATE

(71) Applicant: Meta Platforms Technologies, LLC, Menlo Park, CA (US)

(72) Inventors: Kurt JENKINS, Sammamish, WA (US); Mozhgan TORABIFARD, Bellevue, WA (US); Carl CHANCY, Seattle, WA (US); Harsha Vijay SHAH, Turnhout (BE); John-John VAN DEN BERGH, Turnhout (BE)

(73) Assignee: Meta Platforms Technologies, LLC, Menlo Park, CA (US)

(21) Appl. No.: 18/312,958

(22) Filed: May 5, 2023

(51) Int. Cl. G02B 27/01; B33Y 40/20; B33Y 80/00; C09J 9/00; G02B 1/04

(52) U.S. Cl. CPC G02B 27/0172; B33Y 40/20; B33Y 80/00; C09J 9/00; G02B 1/04; G02B 2027/0178

(57) ABSTRACT

Fabrication of optical lenses in optical assemblies of small form factor cameras and augmented reality (AR)/virtual reality (VR) near-eye display devices is described. An optical lens may be printed using a three-dimensional printing technique over a substrate such as glass following application of an optically clear adhesive (OCA) layer on the substrate. A buffer layer may also be used between the substrate and the OCA layer. Alternatively, a display waveguide may be used as substrate with a low optical index buffer layer between the OCA layer and the waveguide eliminating an air gap between the optical lens and the waveguide.

### TECHNICAL FIELD

This patent application relates generally to optical assemblies, and in particular, to fabricating optical assemblies through three-dimensional printing of optical lenses over rigid substrates and/or waveguides.

### BACKGROUND

Optical lenses have a wide range of implementations from astronomy to microscopy. With recent advances in technology, use of optical lenses in increasingly smaller shape cameras and virtual reality (VR) display systems such as head-mount displays, glasses, etc. have proliferated. While larger optical lenses tend to be manufactured in smaller numbers with individual attention, mass-manufacturing of smaller, yet accurate and reliable optical lenses is a challenging endeavor.

Cameras and virtual reality (VR) display systems such as head-mount displays or glasses commonly include optical assemblies of one or more optical lenses, other optical processing elements, and display elements such as waveguides. While such optical assemblies (and/or elements therein) may be made from rigid materials or formed on rigid substrates, they are subject to deformation.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIGS. 1A-1C illustrate various views of a near-eye display device in the form of a head-mounted display (HMD) device, according to examples.

FIGS. 2A and 2B illustrate a perspective view and a top view of a near-eye display in the form of a pair of glasses, according to an example.

FIG. 3 illustrates an optical lens formed by three-dimensional (3D) printing over a rigid substrate, according to an example.

FIG. 4 illustrates an optical lens formed by three-dimensional (3D)

printing over a rigid substrate with an optically clear adhesive (OCA) layer between the two, according to an example.

FIG. 5 illustrates an optical lens formed by three-dimensional (3D) printing over a waveguide with an optional buffer layer and an optically clear adhesive (OCA) layer between the two, according to examples.

FIGS. 6A and 6B illustrate systems for fabrication of an optical lens through three-dimensional (3D) printing over a rigid substrate or waveguide with an optically clear adhesive (OCA) layer, according to an example.

FIG. 7 illustrates a flow diagram for a method of fabricating an optical assembly with an optical lens and an optically clear adhesive (OCA) layer through three-dimensional (3D) printing over a rigid substrate or waveguide, according to some examples.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Optical lenses may be fabricated in various ways in smaller shape cameras and virtual reality (VR) display systems such as head-mount displays, glasses, etc. While larger optical lenses tend to be manufactured in smaller numbers with individual attention, mass-manufacturing of smaller, yet accurate and reliable optical lenses is a challenging endeavor. Three-dimensional printing is one of the approaches. During three-dimensional printing of optical lenses on a glass substrate, for example, deformation is observed due to volumetric shrinkage and thermal expansion coefficient mismatch. Deformation may make it challenging (or impossible in some cases) to meet flatness requirements for the optical lens.

The present disclosure describes approaches fabrication of optical lenses in optical assemblies of small form factor cameras and augmented reality (AR)/virtual reality (VR) near-eye display devices. In some examples, an optical lens may be printed using a three-dimensional printing technique over a substrate such as glass following application of an optically clear adhesive (OCA) layer on the substrate. A buffer layer may also be used between the substrate and the optically clear adhesive (OCA) layer. In other examples, a display waveguide may be used as substrate with a low optical index buffer layer between the optically clear adhesive (OCA) layer and the waveguide eliminating an air gap between the optical lens and the waveguide.

While some advantages and benefits of the present disclosure are apparent, other advantages and benefits may include improved flatness profile and reduced deformation for optical lens, increased protection for waveguides by eliminating the air gap, higher fabrication success rate, and reduced fabrication cost.

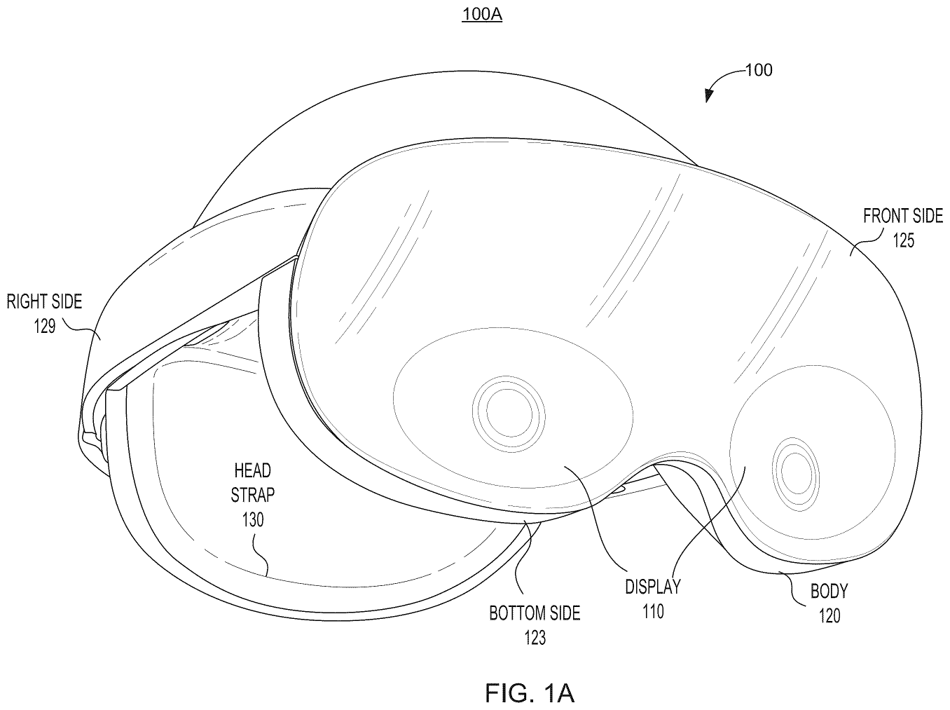

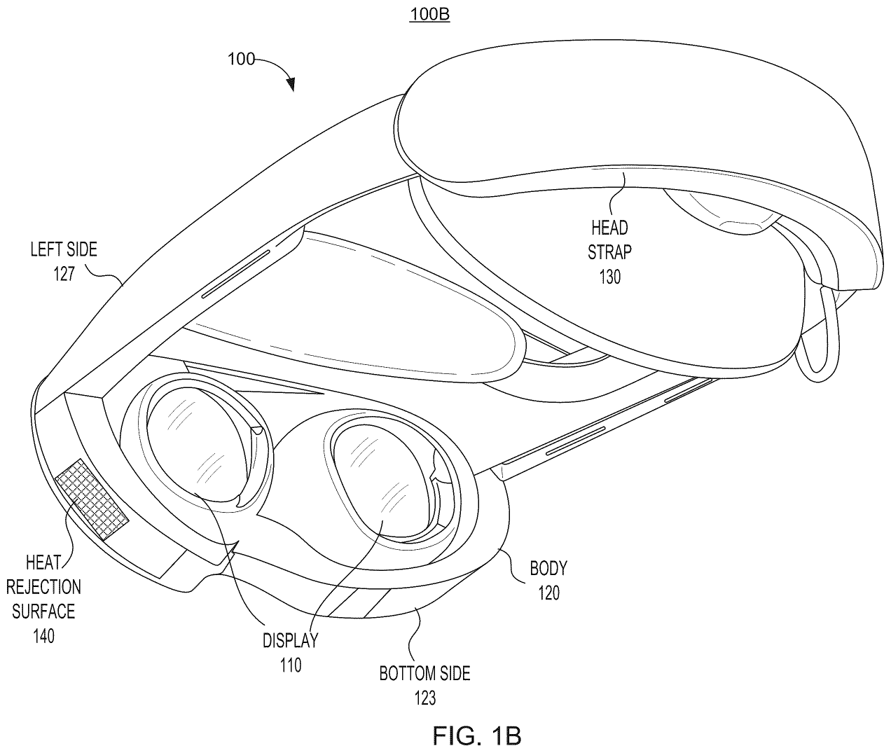

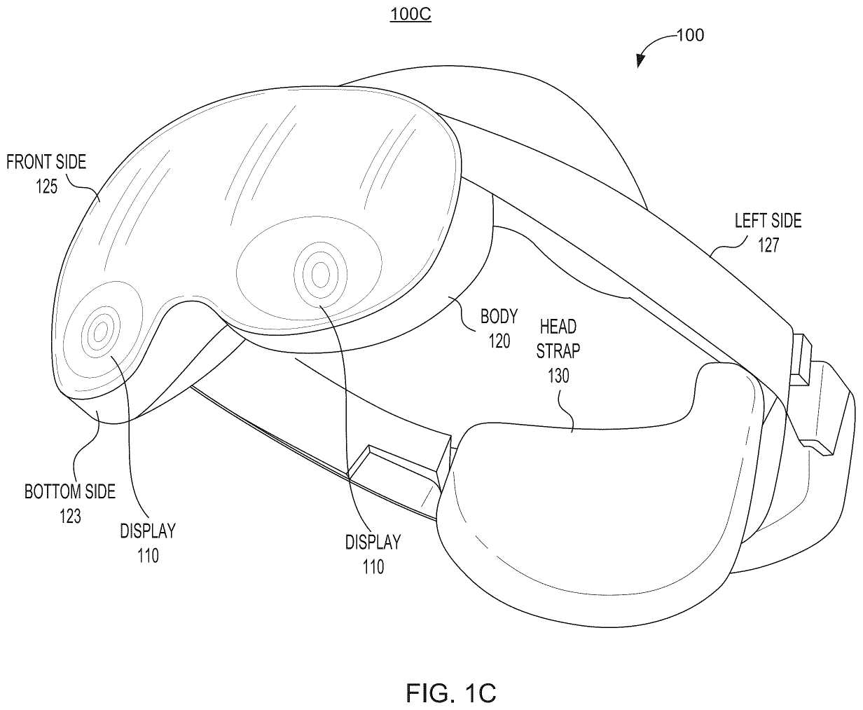

FIGS. 1A-1C illustrate various views of a near-eye display device including at least one heat rejection surface in the form of a head-mounted display (HMD) device, according to examples. In some examples, the head-mounted device (HMD) device 100 may be a part of a virtual reality (VR) system, an augmented reality (AR) system, a mixed reality (MR) system, another system that uses displays or wearables, or any combination thereof. As shown in diagram 100A of FIG. 1A, the head-mounted display (HMD) device 100 may include a body 120 and a head strap 130. The front perspective view of the head-mounted display (HMD) device 100 further shows a bottom side 123, a front side 125, and a right side 129 of the body 120. In some examples, the head strap 130 may have an adjustable or extendible length. In particular, in some examples, there may be a sufficient space between the body 120 and the head strap 130 of the head-mounted display (HMD) device 100 for allowing a user to mount the head-mounted display (HMD) device 100 onto the user's head. For example, the length of the head strap 130 may be adjustable to accommodate a range of user head sizes. In some examples, the head-mounted display (HMD) device 100 may include additional, fewer, and/or different components such as a display 110 to present a wearer augmented reality (AR)/virtual reality (VR) content and a camera to capture images or videos of the wearer's environment.

As shown in the bottom perspective view of diagram 100B of FIG. 1B, the display 110 may include one or more display assemblies and present, to a user (wearer), media or other digital content including virtual and/or augmented views of a physical, real-world environment with computer-generated elements. Examples of the media or digital content presented by the head-mounted display (HMD) device 100 may include images (e.g., two-dimensional (2D) or three-dimensional (3D) images), videos (e.g., 2D or 3D videos), audio, or any combination thereof. In some examples, the user may interact with the presented images or videos through eye tracking sensors enclosed in the body 120 of the head-mounted display (HMD) device 100. The eye tracking sensors may also be used to adjust and improve quality of the presented content. As mentioned herein, the display 210 of the head-mounted display (HMD) device 100 may include one or more optical assemblies with various optical lenses and other optical processing elements. The optical lenses in such assemblies may be fabricated using three-dimensional printing techniques and an optically clear adhesive (OCA) layer between an optical lens and a corresponding substrate, according to some examples.

In some examples, the head-mounted display (HMD) device 100 may include various sensors (not shown), such as depth sensors, motion sensors, position sensors, and/or eye tracking sensors. Some of these sensors may use any number of structured or unstructured light patterns for sensing purposes. In some examples, the head-mounted display (HMD) device 100 may include an input/output interface for communicating with a console communicatively coupled to the head-mounted display (HMD) device 100 through wired or wireless means. In some examples, the head-mounted display (HMD) device 100 may include a virtual reality engine (not shown) that may execute applications within the head-mounted display (HMD) device 100 and receive depth information, position information, acceleration information, velocity information, predicted future positions, or any combination thereof of the head-mounted display (HMD) device 100 from the various sensors.

In some examples, the information received by the virtual reality engine may be used for producing a signal (e.g., display instructions) to the display 110. In some examples, the head-mounted display (HMD) device 100 may include locators (not shown), which may be located in fixed positions on the body 120 of the head-mounted display (HMD) device 100 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

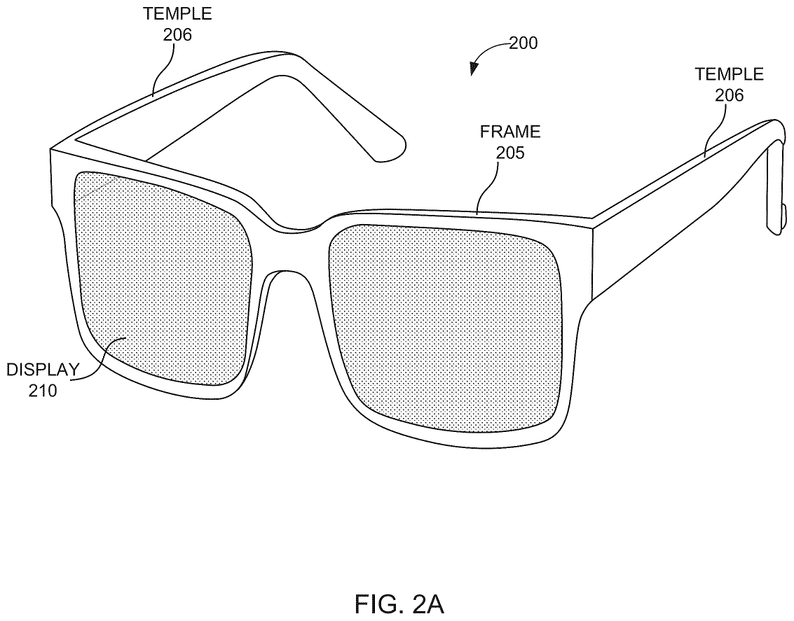

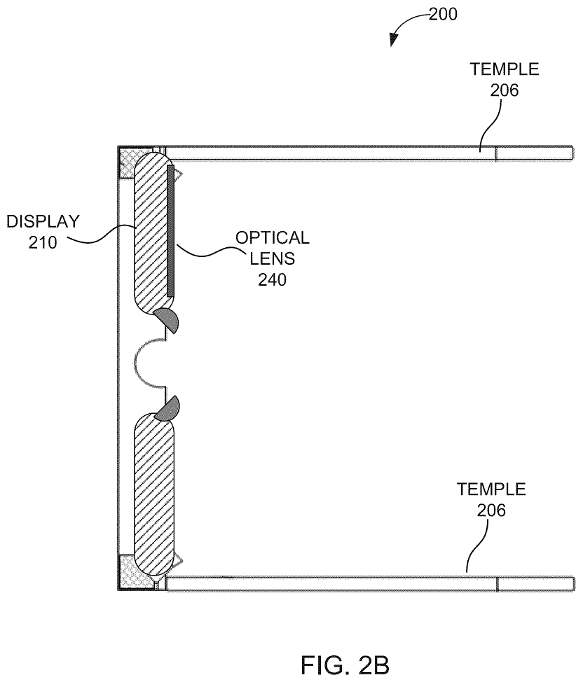

FIG. 2A is a perspective view of a near-eye display 200 including at least one heat rejection surface in the form of a pair of glasses (or other similar eyewear), according to an example. In some examples, the near-eye display 200 may be configured to operate as a virtual reality display, an augmented reality (AR) display, and/or a mixed reality (MR) display.

In some examples, the near-eye display 200 may include a frame 205, two temples 206, and a display 210. In some examples, the display 210 may be configured to present media or other content to a user. In some examples, the display 210 may include display electronics and/or display optics, similar to components described with respect to FIGS. 1A-1C. For example, the display 210 may include a liquid crystal display (LCD) display panel, a light-emitting diode (LED) display panel, or an optical display panel (e.g., a waveguide display assembly). In some examples, the display 210 may also include any number of optical components, such as waveguides, gratings, lenses, mirrors, an optical lens 240, etc. In other examples, the display 210 may include a projector, or in place of the display 210 the near-eye display 200 may include a projector.

In some examples, the near-eye display 200 may further include various sensors on or within a frame 205. In some examples, the various sensors may include any number of depth sensors, motion sensors, position sensors, inertial sensors, and/or ambient light sensors, as shown. In some examples, the various sensors may include any number of image sensors configured to generate image data representing different fields of views in one or more different directions. In some examples, the various sensors may be used as input devices to control or influence the displayed content of the near-eye display, and/or to provide an interactive virtual reality (VR), augmented reality (AR), and/or mixed reality (MR) experience to a user of the near-eye display 200. In some examples, the various sensors may also be used for stereoscopic imaging or other similar applications.

In some examples, the near-eye display 200 may further include one or more illuminators to project light into a physical environment. The projected light may be associated with different frequency bands (e.g., visible light, infra-red light, ultra-violet light, etc.), and may serve various purposes. In some examples, the one or more illuminator(s) may be used as locators.

In some examples, the near-eye display 200 may also include a camera or other image capture unit. The camera, for instance, may capture images of the physical environment in the field of view. In some instances, the captured images may be processed, for example, by a virtual reality engine (e.g., the virtual reality engine 116 of FIG. 1) to add virtual objects to the captured images or modify physical objects in the captured images, and the processed images may be displayed to the user by the display 210 for augmented reality (AR) and/or mixed reality (MR) applications. The near-eye display 200 may also include an eye tracking camera. The display 210 of the near-eye display device 200 may include one or more optical assemblies with various optical lenses and other optical processing elements. The optical lenses in such assemblies may be fabricated using three-dimensional printing techniques and an optically clear adhesive (OCA) layer between the optical lens 240 and a corresponding substrate, according to some examples.

FIG. 2B is a top view of a near-eye display 200 including at least one heat rejection surface in the form of a pair of glasses (or other similar eyewear), according to an example. In some examples, the near-eye display 200 may include a frame 205 and temples 206 having a form factor of a pair of eyeglasses. The frame 205 supports, for each eye: a fringe projector such as any fringe projector variant considered herein, a display 210 to present content to an eye box, an eye tracking camera, and one or more illuminators. The illuminators may be used for illuminating an eye box, as well as, for providing glint illumination to the eye. The fringe projector may provide a periodic fringe pattern onto a user's eye. The display 210 may include a pupil-replicating waveguide to receive the fan of light beams and provide multiple laterally offset parallel copies of each beam of the fan of light beams, thereby extending a projected image over the eye box.

In some examples, the pupil-replicating waveguide may be transparent or translucent to enable the user to view the outside world together with the images projected into each eye and superimposed with the outside world view. The images projected into each eye may include objects disposed with a simulated parallax, so as to appear immersed into the real-world view.

The eye tracking camera may be used to determine position and/or orientation of both eyes of the user. Once the position and orientation of the user's eyes are known, a gaze convergence distance and direction may be determined. The imagery displayed by the display 210 may be adjusted dynamically to account for the user's gaze, for a better fidelity of immersion of the user into the displayed augmented reality scenery, and/or to provide specific functions of interaction with the augmented reality. In operation, the illuminators may illuminate the eyes at the corresponding eye boxes, to enable the eye tracking cameras to obtain the images of the eyes, as well as to provide reference reflections. The reflections (also referred to as “glints”) may function as reference points in the captured eye image, facilitating the eye gazing direction determination by determining position of the eye pupil images relative to the glints. To avoid distracting the user with illuminating light, the latter may be made invisible to the user. For example, infrared light may be used to illuminate the eye boxes.

In some examples, the image processing and eye position/orientation determination functions may be performed by a central controller, not shown, of the near-eye display 200. The central controller may also provide control signals to the display 210 to generate the images to be displayed to the user, depending on the determined eye positions, eye orientations, gaze directions, eyes vergence, etc.

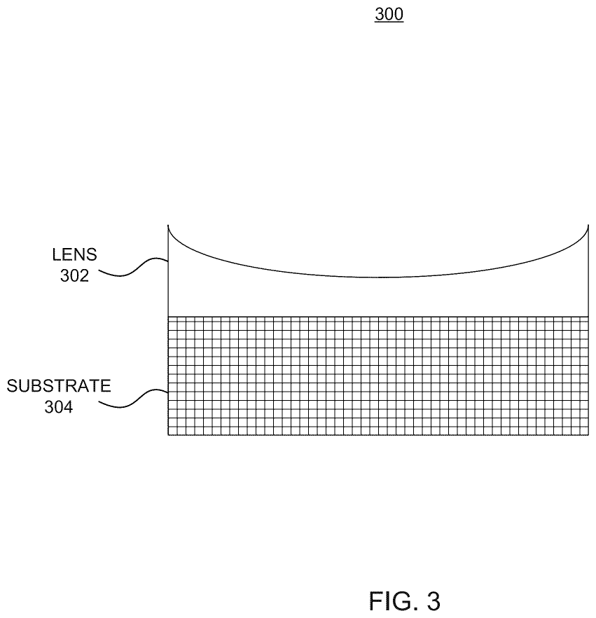

FIG. 3 illustrates an optical lens formed by three-dimensional (3D) printing over a rigid substrate, according to an example. Diagram 300 shows a three-dimensional printed optical lens 302 on a substrate 304.

While conventional optical lenses are formed through machining, casting, and similar techniques, small form factor optical lenses for small cameras and augmented reality (AR)/virtual reality (VR) display devices are fabricated through three-dimensional printing. With the development of faster and more accurate three-dimensional printers, such optical lenses may be printed en mass at desired dimensions. Furthermore, the combination of glass and plastic construction allows for a thin, structural solution for the optical assemblies. There are, however, challenges with creating a monolithic assembly. After printing the lens material may shrink as it cures and cause the substrate to warp. Also, due to the Coefficient of Thermal Expansion (CTE) difference between the substrate and optical lens materials, the optical lens may delaminate from the glass.

In some examples, the substrate may be made from rigid, transparent materials such as glass, polymers, or similar ones. The optical lens may also be made using polymers or polycarbonates, optical grade plastics, etc. Further details on three-dimensional printing of the optical lens 302 are provided below.

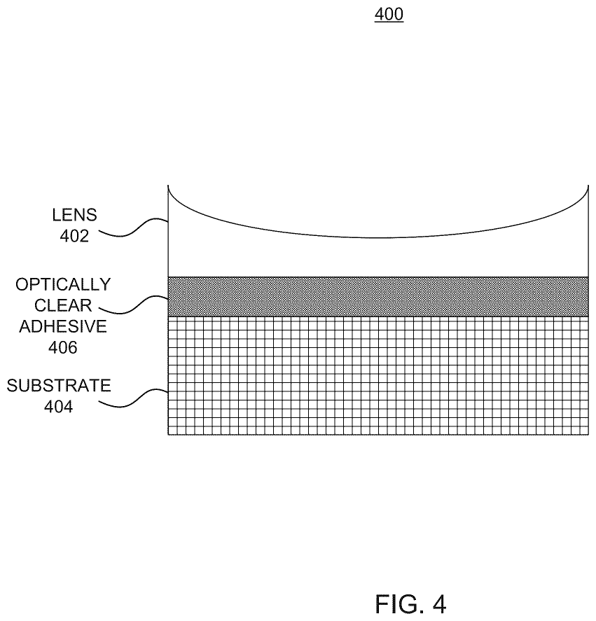

FIG. 4 illustrates an optical lens formed by three-dimensional (3D) printing over a rigid substrate with an optically clear adhesive (OCA) layer between the two, according to an example. Diagram 400 shows an optical lens 402 formed through three-dimensional printing on an optically clear adhesive (OCA) layer 406 applied to a substrate 404.

To mitigate the deformation challenges mentioned herein, an optically clear adhesive (OCA) layer may be applied to laminate the plastic lens to the substrate. The adhesive layer provides a soft boundary between the substrate and the optical lens may reduce the warping of the substrate and improve the coefficient of Coefficient of Thermal Expansion (CTE) mismatch by providing compliance between the layers. Thus, using the optically clear adhesive (OCA) layer may help with the warping, but the process to create a one-piece optical stack is disrupted due to the secondary process of laminating the optical lens onto the substrate. Furthermore, fabricating a thin optical lens for lamination may be difficult and not deliver the same optical performance as a three-dimensional printed optical lens.

In some examples, the substrate 404 may be laminated (e.g., through spraying, screen printing, or similar techniques) with the optically clear adhesive (OCA) layer 406. A thickness of the optically clear adhesive (OCA) layer 406 may be in range from 50 micrometers to 100 micrometers, for example. The optical lens 402 may then be printed onto the optically clear adhesive (OCA) layer 406, where the lens material is directly deposited on top of the adhesive and permanently fixed to the substrate. After printing of the optical lens layer, the optical assembly may be post cured in an oven or with a UV light source.

In some examples, the substrate 404 may be made from materials such as glass, polymer, plastic, polycarbonates, or similar ones. The optical lens 402 may be made from materials such as polymers, polycarbonates, optical grade plastics such as poly-methyl-methacrylate (PMMA), cyclic-olefin-copolymer (COC), cyclo-olefin-polymer (COP), monomer plastic, polymer plastic, polycarbonate (PC), optical nylon, etc. The optical lens 402 may be printed by an inkjet three-dimensional printer layer-by-layer, for example, where a size and drop intensity of the droplets may determine a thickness of the layers. In some applications, the layers may have a thickness in a range from 1 micrometer to 10 micrometers. By selecting/adjusting the thickness of the layers and/or where the layers are deposited, an overall shape of the optical lens (and thereby an optical power of the lens) may be configured.

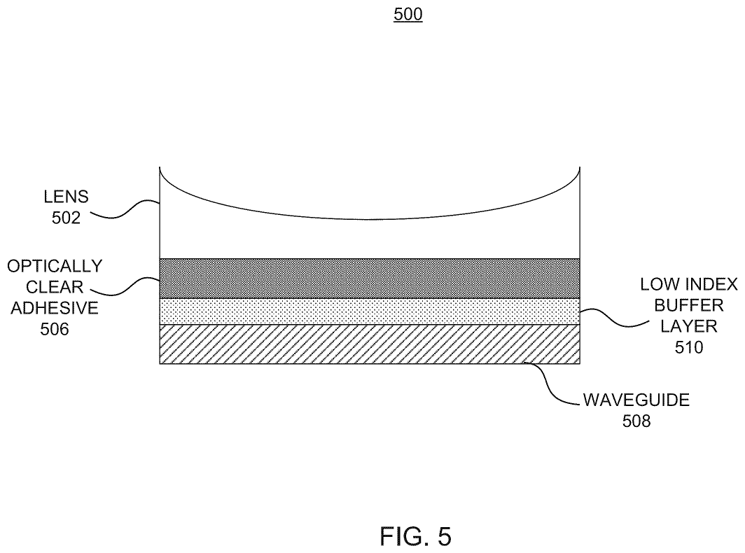

FIG. 5 illustrates an optical lens formed by three-dimensional (3D) printing over a waveguide with an optional buffer layer and an optically clear adhesive (OCA) layer between the two, according to examples. Diagram 500 shows an optical lens 502 formed through three-dimensional printing on an optically clear adhesive (OCA) layer 506 applied to a waveguide 508 with a low index buffer layer 510 between the waveguide 508 and the optically clear adhesive (OCA) layer 506.

As mentioned herein, small form cameras and augmented reality (AR)/virtual reality (VR) display devices include optical assemblies with one or more optical lenses, other optical elements (e.g., phase plates, filters), and, in some cases, a display waveguide. In some augmented reality (AR)/virtual reality (VR) display devices, presentation of content to a wearer may be accomplished by transmission of light from a projector to a waveguide and transmission by the waveguide to an eye box.

In some examples, the waveguide may be utilized to couple light into and/or out of a display system. In particular, and as described further below, light of projected images may be coupled into or out of the waveguide using any number of reflective or diffractive optical elements, such as gratings. For example, as described further below, volume Bragg gratings (VBGs), partial or full reflective components, and other such components may be utilized in a waveguide-based, back-mounted display system (e.g., a pair of glasses or similar eyewear).

In some examples, combination of volume Bragg gratings (VBGs) and/or reflective components may be used to diffract display light from a projector to a user's eye. Furthermore, in some examples, the volume Bragg gratings (VBGs) and/or reflective components may also help compensate for any dispersion of display light caused by each other to reduce the overall dispersion in a waveguide-based display system.

In some examples, the waveguide may include a plurality of layers, such as at least one substrate and at least one photopolymer layer. In some examples, the substrate may be a comprised of a polymer or glass material. The photopolymer layer may be transparent or “see-through” and may include any number of photosensitive materials (e.g., a photo-thermo-refractive glass) or other similar material.

In some examples, the at least one substrate and the at least one photopolymer layer may be optically bonded (e.g., glued on top of each other) to form the waveguide. The overall thickness of the waveguide may be in the range of 0.1-1.6 millimeters (mm) or other thickness range. In some examples, the photopolymer layer may be a film layer having a thickness of anywhere between about 10 to 100 micrometers (μm) or other range.

In some examples, the volume Bragg gratings (VBGs) and/or the reflective components may be provided in (or exposed into) the photopolymer layer. That is, volume Bragg gratings (VBGs) and/or reflective components may be exposed by generating an interference pattern into the photopolymer layer. In some examples, the interference pattern may be generated by superimposing two lasers to create a spatial modulation that may generate the interference pattern in and/or throughout the photopolymer layer. The interference pattern may be a sinusoidal pattern. Also, in some examples, the interference pattern may be made permanent via a chemical, optical, mechanical, or other similar process.

Light traveling within the waveguide through reflection may couple out of the waveguide by being refracted by a grating depending on a wavelength. If a white light source is used different wavelengths that compose the white light may couple out from different gratings.

In some examples, the waveguide may be transparent to visible light and may include, for example, a glass, quartz, plastic, polymer, ceramic, or crystal substrate. The waveguide may include a first surface (i.e., top surface) and a second surface (i.e., the bottom surface). Display light may be coupled into waveguide by an input coupler and may be reflected by the first surface and the second surface through total internal reflection, such that the display light may propagate within the waveguide. A portion of the light may be diffracted by an output grating and couple out, while another portion of the light may be coupled out by another output grating. Each grating may diffract light at a specific angle and wavelength.

To allow seamless transition of light from the waveguide 508 to the optical lens 502, a low index buffer layer 510 may be applied onto the surface of the waveguide 508 first, and the optically clear adhesive (OCA) layer 506 may be applied onto the low index buffer layer 510. In some examples, the substrate (waveguide 508) may be prelaminated with the optically clear adhesive (OCA) layer 506. Alternatively, the optically clear adhesive (OCA) layer 506 may be applied by a second printhead in the three-dimensional printing system (using a different ink). Smoothness of the optically clear adhesive (OCA) layer 506 may be maintained in three-dimensional printing as opposed to pressing because pressure is not needed to realize good adhesion (hard material to hard material lamination). A curvature may be added to the optical lens layer, optically clear adhesive (OCA) layer, or both. The optical lens may be shaped to assist eye tracking relief (freeform shape). Furthermore, by eliminating the air gap between the waveguide and the optical lens, the optical assembly may be thinner allowing a near-eye display device to look more like conventional glasses.

In some examples, deformation may be reduced between a glass substrate only and glass and optically clear adhesive (OCA) configurations by a factor of five or more. Further, warping on the glass substrate (or waveguide) may be reduced even for high diopter optical lenses. Thereby, waviness in the optical assembly may also be reduced. The described approach may also allow thinner optical lenses to be fabricated, for example, with a center thickness of 50 micrometers. Through three-dimensional printing, high optical quality and performance may be achieved.

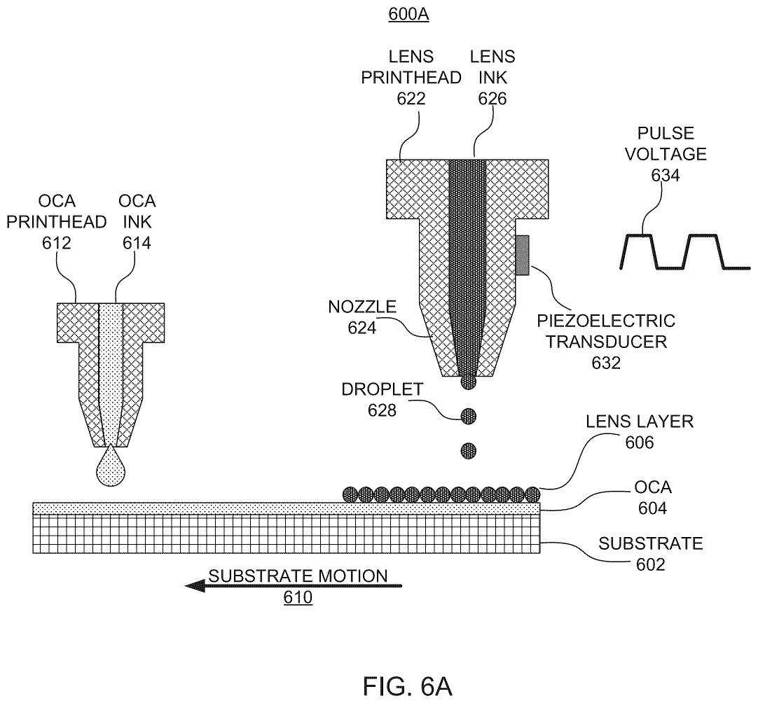

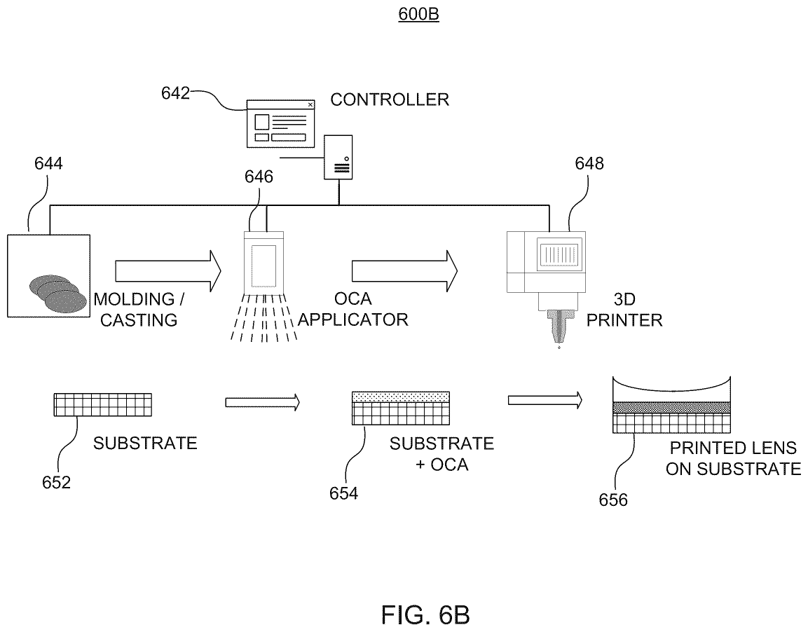

FIGS. 6A and 6B illustrate systems for fabrication of an optical lens through three-dimensional (3D) printing over a rigid substrate or waveguide with an optically clear adhesive (OCA) layer, according to an example.

Diagram 600A in FIG. 6A shows an optically clear adhesive (OCA) printhead 612 with optically clear adhesive (OCA) ink 614 applying the optically clear adhesive (OCA) material onto a substrate 602 as optically clear adhesive (OCA) layer 604 as the substrate 602 is moved in a direction 610. An optical lens printhead 622 with optical lens ink 626 may apply the optical lens ink 626 through a nozzle 624 as droplets 628 onto the optically clear adhesive (OCA) layer 604 forming the optical lens layer 606. The substrate 602 may be moved (e.g., along direction 610) linearly or planarly as the droplets 628 fall allowing a layer of print material with a thickness of one droplet to be formed on the substrate 602. A piezoelectric transducer 632 actuated by a pulse voltage 634 may generate a pressure pulse causing the droplets 628 to be ejected by the nozzle 624. Coordination between the electronics of the three-dimensional printer and the motion system may enable digital patterning of complex layouts on planar surfaces such as the outer layer on an inner layer of the optical lens.

In some examples, the print material (ink 626) may be liquified prior to being provided to the nozzle 624 and cured (e.g., through photo-curing or cooling) on the substrate. In other examples, the print material may be liquified inside the nozzle by applying heat. In an example three-dimensional printer of optical lenses, picoliter size droplets may be ejected by the nozzle 624 resulting in optical lens layer thickness ranging from sub-micrometers to 10 micrometers.

Diagram 600B of FIG. 6B shows an optical lens manufacturing system with a controller 642, a substrate generator 644 (e.g., a molding machine or a casting machine), an optically clear adhesive (OCA) applicator 646, and a three-dimensional printer 648. As shown in the optical assembly manufacturing system, the substrate 652 (or waveguide) may be provided from the substrate generator 644 to the optically clear adhesive applicator 646; the substrate with the optically clear adhesive (OCA) layer 654 may be provided to the three-dimensional printer 648, where the optical assembly 656 may be provided as output of the three-dimensional printer 648.

In some examples, the substrate 652 may be formed through injection molding, machine casting, compression molding, or similar methods at the substrate generator 644. Similarly, a waveguide may also be formed as discussed herein. The optically clear adhesive (OCA) applicator 646 may apply the optically clear adhesive (OCA) onto the substrate 652 through spraying, screen printing, or similar methods. In other examples, the optically clear adhesive (OCA) may be applied by three-dimensional printing through another printhead using liquid optically clear adhesive material as ink.

In some examples, the controller 642 may be communicatively coupled through wired or wireless media to the substrate generator 644, optically clear adhesive (OCA) applicator 646, and/or the three-dimensional printer 648, and control part or all of their operations. For example, the controller 642 may store machine-readable instructions on a non-transitory computer readable medium and execute through a processor or other type of processing circuit to perform one or more operations described herein.

In some examples, the controller 642, the substrate generator 644, the optically clear adhesive (OCA) applicator 646, and the three-dimensional printer 648 may be distinct devices or systems that are communicatively coupled. In other examples, the devices or systems may be partially or wholly integrated. A system for fabricating optical assemblies as described herein may include additional or fewer components with performing additional or similar functionality as the described components.

The optical assembly fabrication system may further (or optionally) include a curing module to cure the optically clear adhesive (OCA) layer post three-dimensional printing of the optical lens and/or a buffer layer applicator to form the low index buffer layer on the waveguide.

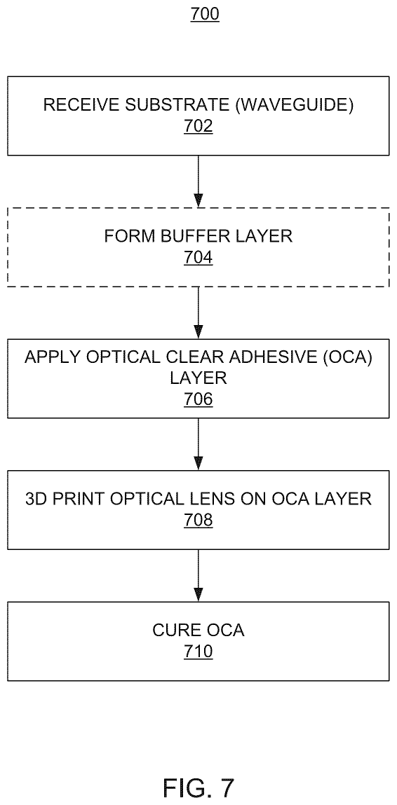

FIG. 7 illustrates a flow diagram for a method 700 of fabricating an optical assembly with an optical lens and an optically clear adhesive (OCA) layer through three-dimensional (3D) printing over a rigid substrate or waveguide, according to some examples. The method 700 is provided by way of example, as there may be a variety of ways to carry out the method described herein. Although the method 700 is primarily described as being performed by the components of FIGS. 6A and 6B, the method 700 may be executed or otherwise performed by one or more processing components of another system or a combination of systems. Each block shown in FIG. 7 may further represent one or more processes, methods, or subroutines, and one or more of the blocks may include machine readable instructions stored on a non-transitory computer readable medium and executed by a processor or other type of processing circuit to perform one or more operations described herein.

At block 702, a substrate or a waveguide may be received for integration with an optical lens. The substrate may be formed through injection molding, machine casting, compression molding, or similar methods. The wave guide may also be formed as discussed herein. The substrate may be made from materials such as glass, polymer, plastic, polycarbonates, or similar ones.

At optional block 704, a buffer layer may be formed on a surface of the waveguide. To ensure seamless transition of the light from the waveguide to the optical lens, the low index buffer layer may be used.

At block 706, an optically clear adhesive (OCA) may be applied onto the substrate or the buffer layer on the waveguide. The optically clear adhesive may be applied by spraying, screen printing, or by three-dimensional printing.

At block 708, the optical lens may be formed on the optically clear adhesive (OCA) layer by three-dimensional printing. The optical lens may be made from materials such as polymers, polycarbonates, optical grade plastics such as poly-methyl-methacrylate (PMMA), cyclic-olefin-copolymer (COC), cyclo-olefin-polymer (COP), monomer plastic, polymer plastic, polycarbonate (PC), optical nylon, etc. The optical lens may be printed by an inkjet three-dimensional printer layer-by-layer, for example, where a size and drop intensity of the droplets may determine a thickness of the layers. At block 710, the optically clear adhesive (OCA) may be cured by UV light application or heat application.

According to examples, a method of fabricating an optical lens on a substrate with an optically clear adhesive (OCA) layer between the substrate and the optical lens is described herein. A system of fabricating the optical lens is also described herein. A non-transitory computer-readable storage medium may have an executable stored thereon, which when executed instructs a processor to perform the methods described herein.

In the foregoing description, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A method for fabricating an optical assembly, the method comprising:
receiving a waveguide;
depositing a buffer layer on the waveguide;
depositing an optically clear adhesive (OCA) layer onto the buffer layer; and
depositing an optical lens onto the OCA layer by three-dimensional printing.

2. The method of claim 1, further comprising:
curing the OCA layer using ultraviolet (UV) light or heat.

3. The method of claim 1, wherein depositing the OCA layer onto the buffer layer comprises:
spraying;
screen printing; or
three-dimensional printing.

4. The method of claim 1, further comprising:
forming a curvature of the optical assembly in one or both of the optical lens and the OCA layer.

5. The method of claim 1, wherein the optical lens is made from a polymer, a polycarbonate (PC), poly-methyl-methacrylate (PMMA), cyclic-olefin-copolymer (COC), cyclo-olefin-polymer (COP), a monomer, or an optical nylon.

6. The method of claim 1, wherein the optical lens is deposited layer-by-layer.

7. The method of claim 6, wherein at least one of a thickness or an optical power of the optical lens is determined by at least one of a thickness or a length of each layer deposited by a three-dimensional printhead.

8. The method of claim 1, wherein the buffer layer comprises a low index buffer layer.

9. The method of claim 1, wherein a thickness of the OCA layer is in a range from 50 micrometers to 100 micrometers.

10. A method for fabricating an optical assembly, the method comprising:
receiving a substrate;
depositing an optically clear adhesive (OCA) layer onto the substrate; and
depositing an optical lens onto the OCA layer by three-dimensional printing.

11. The method of claim 10, further comprising:
curing the OCA layer using ultraviolet (UV) light or heat.

12. The method of claim 10, wherein depositing the OCA layer onto the substrate comprises:
spraying;
screen printing; or
three-dimensional printing.

13. The method of claim 10, further comprising:
forming a curvature of the optical assembly in one or both of the optical lens and the OCA layer.

14. The method of claim 10, wherein
the substrate is made from glass, polymer, plastic, a polycarbonates; and
the optical lens is made from a polymer, a polycarbonate (PC), poly-methyl-methacrylate (PMMA), cyclic-olefin-copolymer (COC), cyclo-olefin-polymer (COP), a monomer, or an optical nylon.

15. The method of claim 10, wherein
the optical lens is deposited layer-by-layer; and
at least one of a thickness or an optical power of the optical lens is determined by at least one of a thickness or a length of each layer deposited by a three-dimensional printhead.

16. The method of claim 10, wherein the substrate further comprises a waveguide to receive light from a projector.

17. A system to fabricate an optical assembly, the system comprising:
a substrate generator to receive or fabricate a substrate;
an optically clear adhesive (OCA) applicator to apply an OCA layer onto the substrate;
a three-dimensional printer to deposit an optical lens onto the OCA layer through three-dimensional printing; and
a controller communicatively coupled to the substrate generator, the OCA applicator, and the three-dimensional printer, the controller to manage operations of at least one of the substrate generator, the OCA applicator, or the three-dimensional printer.

18. The system of claim 17, wherein the substrate is a waveguide and the system further comprises:
a buffer layer applicator to deposit a low index buffer layer onto the waveguide prior to application of the OCA layer.

19. The system of claim 17, further comprising:
a curing module to cure the OCA layer by ultraviolet (UV) light or heat application.

20. The system of claim 17, wherein
the three-dimensional printer is to control at least one of a thickness or an optical power of the optical lens by adjusting at least one of a thickness or a length of each deposited layer.
